(19) United States
(12) Patent Application Publication
(10) Pub. No.: US 2022/0156299 A1
(43) Pub. Date: May 19, 2022

(54) DISCOVERING OBJECTS IN AN ONTOLOGY DATABASE

(71) Applicant: International Business Machines Corporation, Armonk, NY (US)

(72) Inventors: Karina Elayne Kervin, Sacramento, CA (US); Satyajeet Raje, White Plains, NY (US)

(21) Appl. No.: 17/097,960

(22) Filed: Nov. 13, 2020

(51) Int. Cl. G06F 16/33; G06F 16/338; G06F 16/901; G06F 16/36

(52) U.S. Cl. CPC G06F 16/3344; G06F 16/367; G06F 16/9024; G06F 16/338

(57) ABSTRACT

A computer-implemented method, system and computer program product for discovering objects in a database containing a populated ontology. A first network is constructed with objects as the nodes and the shared concepts as the edges between the objects. A second network is constructed with nodes corresponding to the terms related to the search term and the search term synonyms and objects associated with the search term and the search term synonyms, where the edges correspond to the relationships between the terms and the objects. First and second scores are generated for each object in an ontology database based on the first and second networks, respectively, which are combined to form a final score for each object in the ontology database. After ranking the objects in the ontology database based on their associated final scores, objects from the ontology database are presented to the user based on their rank.

### TECHNICAL FIELD

The present disclosure relates generally to database search systems, and more particularly to discovering objects (e.g., documents) in an ontology database that correspond to the desired search query results.

### BACKGROUND

Data is a valuable resource, and reusing such data increases this value. There are many benefits in reusing data, such as eliminating the time in recreating the data as well as increasing innovation.

The challenge though with reusing data is the ability to efficiently and effectively locate the desired data, such as in a database, to be reused. A database search system may include a database search engine used to locate such data. Such database search systems may utilize metadata (data about data) to address this challenge by providing additional information about the stored data thereby assisting the user in locating the desired data.

Furthermore, ontologies may be utilized to further assist in locating the relevant data. An ontology defines a set of representational primitives with which to model a domain of knowledge or discourse. That is, ontologies are a model of the concepts and objects (e.g., documents, web pages) within a domain and the relationships between those concepts and objects. As a result, ontologies tie metadata together into a cohesive framework thereby making searching for data easier.

However, when searching for data in such ontologies by the database search system via a search query, the search results may include hundreds or thousands of results. Unfortunately, metadata may not be enough to assist the analyst or data scientist in discovering the relevant data quickly without paging through hundreds or thousands of results.

### SUMMARY

In one embodiment of the present disclosure, a computer-implemented method for discovering objects in a database containing a populated ontology comprises constructing a first network with objects as nodes and shared concepts as edges between the objects. The method further comprises calculating a first score for each object in the ontology database to determine an object importance based on a number of connections in the first network to other objects and based on a number of connections in the first network to objects with a number of connections to other objects that exceeds a threshold number. The method additionally comprises receiving a search term. Furthermore, the method comprises determining terms that are synonyms to the search term. Additionally, the method comprises constructing a second network with nodes corresponding to terms related to the search term and the search term synonyms and objects associated with the search term and the search term synonyms, where edges of the second network correspond to relationships between the terms related to the search term and the search term synonyms and the objects associated with the search term and the search term synonyms. In addition, the method comprises calculating a second score for each object in the ontology database based on a number of connections in the second network to the search term and the search term synonyms and based on a number of connections in the second network to the terms related to the search term and the search term synonyms. The method further comprises combining the first and second scores to obtain a final score for each object in the ontology database. The method additionally comprises ranking objects in the ontology database based on associated final scores. Furthermore, the method comprises presenting objects from the ontology database to a user based on their associated rank.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the object discovery system used to discover the objects within the ontology database that correspond to the relevant data sought by the user in accordance with an embodiment of the present disclosure;

FIG. 3 illustrates an embodiment of the present disclosure of the hardware configuration of the object discovery system which is representative of a hardware environment for practicing the present disclosure;

FIG. 4 is a flowchart of a method for assessing an object's importance in accordance with an embodiment of the present disclosure; and

FIG. 5 is a flowchart of a method for assessing an object's search relevance which is used in combination with the assessed object's importance to discover objects in the ontology database corresponding to the relevant data sought by the user in accordance with an embodiment of the present disclosure.

### DETAILED DESCRIPTION

As stated in the Background section, data is a valuable resource, and reusing such data increases this value. There are many benefits in reusing data, such as eliminating the time in recreating the data as well as increasing innovation.

The challenge though with reusing data is the ability to efficiently and effectively locate the desired data, such as in a database, to be reused. A database search system may include a database search engine used to locate such data. Such database search systems may utilize metadata (data about data) to address this challenge by providing additional information about the stored data thereby assisting the user in locating the desired data.

Furthermore, ontologies may be utilized to further assist in locating the relevant data. An ontology defines a set of representational primitives with which to model a domain of knowledge or discourse. That is, ontologies are a model of the concepts and objects (e.g., documents, web pages) within a domain and the relationships between those concepts and objects. As a result, ontologies tie metadata together into a cohesive framework thereby making searching for data easier.

However, when searching for data in such ontologies by the database search system via a search query, the search results may include hundreds or thousands of results. Unfortunately, metadata may not be enough to assist the analyst or data scientist in discovering the relevant data quickly without paging through hundreds or thousands of results.

One existing approach to attempt to identify the relevant data sought by the user by the database search system is using text analysis on the search query. Such an approach ranks the similarity of the search query to the ontology concepts. In such an approach though, the results are poor when there is a little amount of text to analyze, such as in a data search.

Another approach to attempt to identify the relevant data sought by the user by the database search system is weighting the concepts in an ontology using a probabilistic approach to assess the information content and using those weights to rank the results. However, objects that are associated with many different concepts are penalized. Furthermore, differentiating between objects associated with concept(s) at the same level is difficult.

As a result, there is not currently a means for database search systems to efficiently and effectively identify the relevant data sought by the user, such as by effectively ranking the search results. Furthermore, such database search systems expend a tremendous amount of computing resources (e.g., processing resources) in attempting to locate the desired data.

The embodiments of the present disclosure provide a means for efficiently and effectively identifying the relevant data sought by the user by discovering objects in a database containing a populated ontology (“ontology database”) using a two-stage solution that considers the object relevance to the search terms as well as the object's potential usefulness when ranking the results. In one embodiment, “usefulness” of an object is determined based on the object's connections to other objects and the connections to objects with a number of connections to other objects that exceeds a threshold (such objects are referred to herein as “highly connected objects”). Furthermore, the principles of the present disclosure allow the inclusion of information beyond the relationship to other objects and/or concepts within the ontology as discussed further below.

In some embodiments of the present disclosure, the present disclosure comprises a computer-implemented method, system and computer program product for discovering objects in a database containing a populated ontology. In one embodiment of the present disclosure, an object discovery system constructs a first network with objects as the nodes and the shared concepts (concepts shared between the objects) as the edges between the objects (the objects with the shared concept). A “node,” as used herein, refers to the vertex of the network. An “edge,” as used herein, refers to a link in the network (or graph) that is one of the connections between the nodes (or vertices) of the network. The object discovery system calculates a score (object importance score) for each object in the ontology database to determine an object importance based on the number of connections in the first network to other objects and based on the number of connections in the first network to the objects with a number of connections to other objects that exceeds a threshold number. After receiving a search term from a user, the object discovery system determines terms that are synonyms to the search term. A second network is then constructed by the object discovery system with nodes corresponding to the terms related to the search term and the search term synonyms and objects associated with the search term and the search term synonyms, where the edges of the second network correspond to the relationships between the terms and the objects. The object discovery system then calculates a score (“search relevance score”) for each object in the ontology database based on the number of connections in the second network to the search term and the search term synonyms and based on the number of connections in the second network to the terms related to the search term and the search term synonyms. These scores (object importance score and the search relevance score) are combined to form a final score for each object. After ranking the objects in the ontology database based on their associated final scores, the object discovery system presents those objects from the ontology database to the user based on their rank, where those objects with the highest final scores will be presented to the user prior to those objects associated with a lower score. In this manner, the relevance to search terms and the potential usefulness are taken into account when ranking results thereby more efficiently and effectively identifying the relevant data sought by the user. Furthermore, by taking into account the relevance to search terms and the potential usefulness, the objects are identified in the ontology database using fewer computing resource (e.g., fewer processing resources) than prior database search systems.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

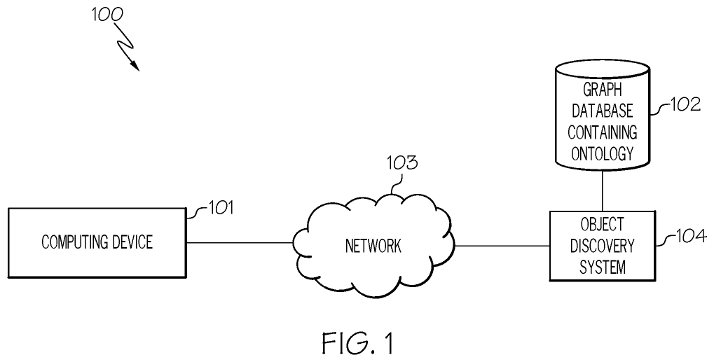

Referring now to the Figures in detail, FIG. 1 illustrates an embodiment of the present disclosure of a communication system 100 for practicing the principles of the present disclosure. Communication system 100 includes a computing device 101 configured to search for data contained in a database 102, such as a graph database containing an ontology as shown in FIG. 1, via a network 103 and an object discovery system 104. Such a search may be conducted by the user of computing device 101 submitting a search query to a database search system, such as object discovery system 104, via network 103. Object discovery system 104 is connected to network 103 by wire or wirelessly. Upon receiving the search query from computing device 101, object discovery system 104 then discovers the objects (e.g., documents, web pages, descriptions of physical objects within an electronic archive, etc.) within database 102 (also referred to herein as the “ontology database”) connected to object discovery system 104 that correspond to the relevant data sought by the user of computing device 101. It is noted that both computing device 101 and the user of computing device 101 may be identified with element number 101.

Computing device 101 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 103 and consequently communicating with object discovery system 104 to search for objects contained in database 102.

As previously discussed, in one embodiment, database 102 (also referred to as an “ontology database”) contains an ontology. An ontology defines a set of representational primitives with which to model a domain of knowledge or discourse. That is, ontologies are a model of the concepts and objects (e.g., documents, web pages) within a domain and the relationships between those concepts and objects. An “object,” as used herein, refers to a representation of things in the virtual and physical world, such as documents, web pages, description of physical objects within an electronic archive, etc. A “concept,” as used herein, refers to an abstract idea or a general notion, such as a mental representation. For example, the ontology may include the concept of travel associated with the objects of www.travel.state.org; www.cdc.gov; www.dhs.gov; www.ucop.edu; www.fda.gov; “What Documents Do I Need to Travel Overseas?” by Shannon Bradford, etc.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

Furthermore, as discussed above, system 100 includes object discovery system 104 configured to discover the objects (e.g., documents, web pages, descriptions of physical objects within an electronic archive, etc.) within ontology database 102 that correspond to the relevant data sought by the user of computing device 101. In one embodiment, object discovery system 104 uses a two-stage solution that considers the object relevance to the search terms as well as the object's potential usefulness or importance when ranking the results. In one embodiment, “usefulness” of an object is determined based on the object's connections to other objects and the connections to objects with a number of connections to other objects that exceeds a threshold (such objects are referred to herein as “highly connected objects”).

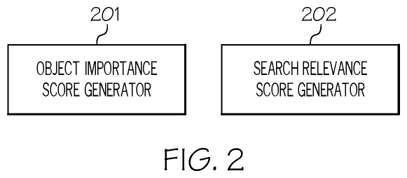

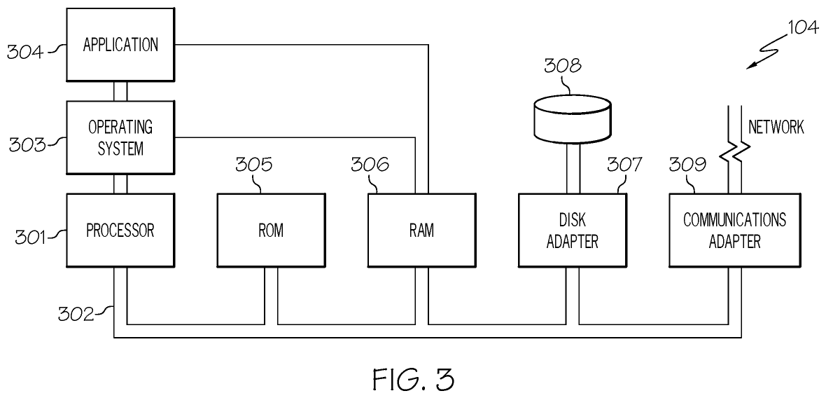

A discussion regarding the software components used by object discovery system 104 to perform such functions is discussed below in connection with FIG. 2. Furthermore, a description of the hardware configuration of object discovery system 104 is provided further below in connection with FIG. 3.

FIG. 2 is a diagram of the software components of object discovery system 104 (FIG. 1) used to discover the objects within ontology database 102 (FIG. 1) that correspond to the relevant data sought by the user of computing device 101 (FIG. 1) in accordance with an embodiment of the present disclosure.

Referring to FIG. 2, in conjunction with FIG. 1, object discovery system 104 includes an object importance score generator 201 configured to generate a score for each object within ontology database 102 based on the number of connections to other objects as well as based on the connections to those objects (“highly connected objects”) with a number of connections to other objects that exceeds a threshold number.

In one embodiment, object importance score generator 201 queries ontology database 102 for all objects and their associated concepts. In one embodiment, ontology database 102 contains an ontology which contains a representation, formal naming and definition of the categories, properties and relations between objects and concepts. An “object,” as used herein, refers to a representation of things in the virtual and physical world, such as documents, web pages, description of physical objects within an electronic archive, etc. A “concept,” as used herein, refers to an abstract idea or a general notion, such as a mental representation. For example, the ontology may include the concept of travel associated with the objects of www.travel.state.org; www.cdc.gov; www.dhs.gov; www.ucop.edu; www.fda.gov; “What Documents Do I Need to Travel Overseas?” by Shannon Bradford, etc. In one embodiment, such an ontology may be established an expert.

In one embodiment, object importance score generator 201 constructs a network with such identified objects as the nodes, where the shared concepts (concepts shared between the objects) are the edges between the objects (the objects with the shared concept). A “shared concept,” as used herein, refers to a concept that is associated with multiple objects in the ontology. For example, the objects of www.travel.state.org and www.cdc.gov are associated with the shared concept of travel. A “node,” as used herein, refers to the vertex of the network. An “edge,” as used herein, refers to a link in the network (or graph) that is one of the connections between the nodes (or vertices) of the network. Edges may be directed, such as pointing from one node to the next. Alternatively, edges may be bidirectional. In one embodiment, the edges are limited to certain types of concept relationships.

In one embodiment, object importance score generator 201 then generates a score (“object importance score”) for each object in ontology database 102 based on the number of connections in the network to other objects and based on the number of connections in the network to those objects with a number of connections to other objects that exceeds a threshold number. A “connection,” as used herein, refers to the line between the objects in the network. In one embodiment, such a score is equal to the number of such connections. In one embodiment, such a score is normalized between the values of 0 and 1, with the value of 1 corresponding to the highest score that was generated by object importance score generator 201 for an object in ontology database 102.

In this manner, the potential “usefulness” of an object may be assessed. That is, an importance score is assigned to all objects managed within the ontology based on how these objects connect to each other. As a result, such a score allows for differentiation even when a search is for a single concept with no related concepts. Hence, those objects that are most likely to be “useful” because they contain a large amount of information or act as a connection between other highly useful objects are identified.

In one embodiment, object importance score generator 201 generates such a score via a microservice that is called at the time of a data refresh.

In one embodiment, other object features, such as data quality, may be utilized to calculate the object importance, such as providing a weight to the above-discussed calculations.

In one embodiment, the score generated by object importance score generator 201 is stored in ontology database 102 in association with the object whose potential usefulness was evaluated.

While the foregoing discusses calculating a score based on the number of connections in the network to other objects and the number of connections in the network to those objects with a number of connections to other objects that exceeds a threshold number, other network-based measurements directed to assessing the object's potential usefulness may be utilized to make such a calculation. A person of ordinary skill in the art would be capable of applying the principles of the present disclosure to such implementations. Further, embodiments applying the principles of the present disclosure to such implementations would fall within the scope of the present disclosure.

Object discovery system 104 further includes a search relevance score generator 202 configured to generate a score for each object in ontology database 102 based on the number of connections in a network to the search term and the search term synonyms and based on the number of connections in the network to terms related to the search terms (the search term and the search term synonyms).

In one embodiment, search relevance score generator 202 receives a search term and determines the terms that are synonyms to the search term. In one embodiment, such synonyms are determined based on a table containing a listing of synonyms for various terms. In one embodiment, search relevance score generator 202 performs a table look-up in such a table using the search term(s) provided by the user of computing device 101 to identify synonyms for such terms. In one embodiment, such a table is stored in a storage device of object discovery system 104 (e.g., memory 305, disk unit 308 of FIG. 3).

In one embodiment, search relevance score generator 202 queries ontology database 102 for objects (e.g., documents, web pages, descriptions of physical objects within an electronic archive, etc.) associated with the search term and the search term synonyms. In one embodiment, ontology database 102 contains an ontology, which may be populated by an expert, which contains a representation, formal naming and definition of the categories, properties and relations between objects. For example, the ontology may include objects associated with various categories. For instance, the objects of www.travel.state.org; www.cdc.gov; www.dhs.gov; www.ucop.edu; www.fda.gov; “What Documents Do I Need to Travel Overseas?” by Shannon Bradford, etc. may be associated with the category of international travel. Hence, if the search term (or search term synonym) included the phrase international travel, then such objects may be identified.

Furthermore, in one embodiment, search relevance score generator 202 queries ontology database 102 for all terms related to the search term and search term synonyms. In one embodiment, ontology database 102 further contains an ontology, which may be populated by an expert, which contains a representation, formal naming and definition of the categories, properties and relations between terms. For example, the ontology may include a food ontology class, which includes the category of food, the sub-categories of breads, cereals, rice, pasta and noodles; vegetables and legumes; fruit; milk, yogurt and cheese; meat, fish, poultry, eggs and nuts. Each of these sub-categories may include further sub-categories, such as the sub-category of milk having the further sub-categories of soy milk, almond milk, rice milk, goat milk and cow milk. Hence, if the search term (or search term synonym) included the term “food,” then any of these terms may be identified. In a further example, if the search term (or search term synonym) included the term “milk,” then the tennis of soy milk, almond milk, rice milk, goat milk and cow milk may be identified.

In one embodiment, search relevance score generator 202 constructs a network with the terms and objects discussed above as nodes and the relationships between the terms and objects as edges. A “relationship,” as used herein, refers to the connection in the ontology of ontology database 102 between the terms and objects. In one embodiment, ontology database 102 contains an ontology which contains a representation, formal naming and definition of the categories, properties and relations between objects and terms. For example, the ontology may include objects associated with various terms. For instance, the term “milk” may be associated with the article of “5 Ways that Drinking Milk can Improve Your Health” by Jillian Kubala and the web page of www.food.com/about/milk-360. Hence, if the term is “milk,” then such objects will be connected to such a term in the constructed network as an edge.

In one embodiment, search relevance score generator 202 generates a score (“search relevance score”) for each object in ontology database 102 based on the number of connections in the network to the search term and the search term synonyms and based on the number of connections in the network to terms related to the search terms (the search term and the search term synonyms). As a result, search relevance scores are assigned to objects based on how closely an object's associated concepts are related to the search concept.

In one embodiment, terms related to the search terms are determined based on querying ontology database 102 for such terms as discussed above. For example, the ontology may include the category for the search term of “milk” with the sub-category of “formula.” Hence, the term “formula” may be identified as being a term related to the search term of “milk.” As a result, search relevance score generator 202 generates a score for each object in ontology database 102 based on the number of connections in the network to the search term (e.g., “milk”) and the search term synonyms (e.g., “soy milk”) and based on the number of connections in the network to terms related to the search terms (e.g., “formula”). In one embodiment, such a score is equal to the number of such connections. In one embodiment, such a score is normalized between the values of 0 and 1, with the value of 1 corresponding to the highest score that was generated by search relevance score generator 202 for an object in ontology database 102.

In one embodiment, search relevance score generator 202 of object discovery system 104 generates such a score via a microservice that is called when the user, such as the user of computing device 101, searches the ontology in ontology database 102..

As will be discussed in greater detail below, the scores provides by object importance score generator 201 and search relevance score generator 202 will be combined to obtain a final score for each object. The objects will then be ranked based on the final score and presented to a user (e.g., user of computing device 101) based on the rank. For example, those objects with the highest final score will be presented to the user of computing device 101 prior to those objects associated with a lower score.

In this manner, the relevance to search terms and the potential usefulness are taken into account when ranking results thereby more efficiently and effectively identifying the relevant data sought by the user. Furthermore, by taking into account the relevance to search terms and the potential usefulness, the objects are identified in the ontology database 102 using fewer computing resource (e.g., fewer processing resources) than prior database search systems.

Returning to FIG. 1, system 100 is not to be limited in scope to any one particular network architecture. System 100 may include any number of computing devices 101, ontology databases 102, networks 103 and object discovery systems 104.

Referring now to FIG. 3, FIG. 3 illustrates an embodiment of the present disclosure of the hardware configuration of object discovery system 104 (FIG. 1) which is representative of a hardware environment for practicing the present disclosure.

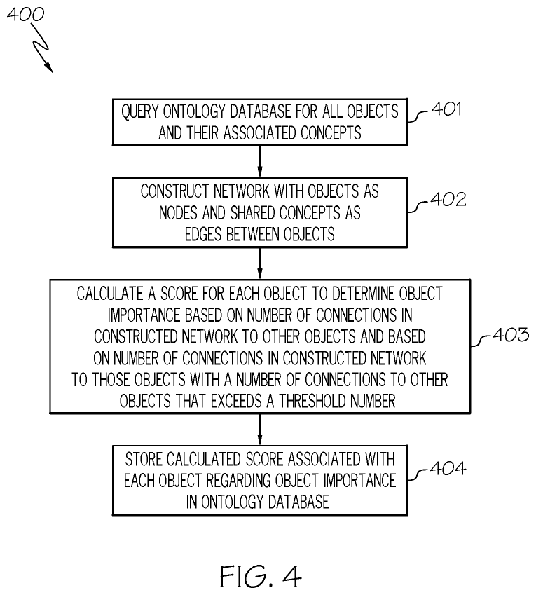

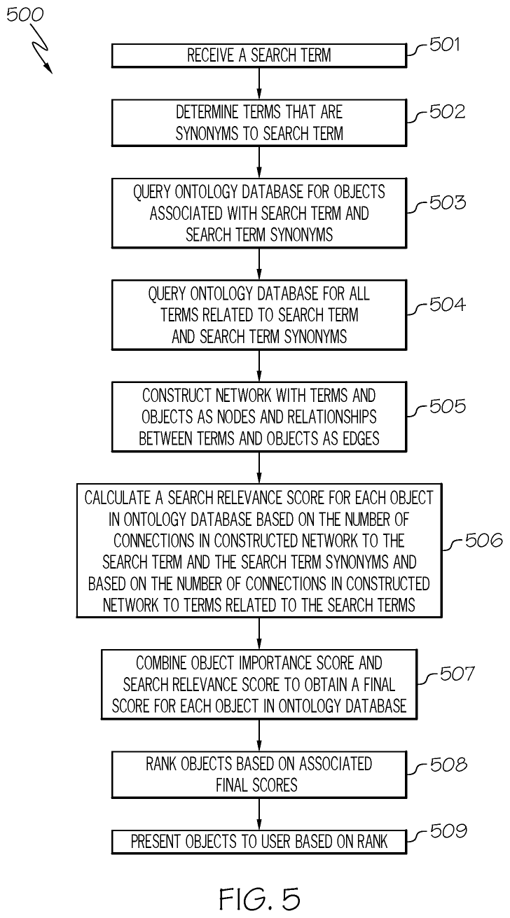

Object discovery system 104 has a processor 301 connected to various other components by system bus 302. An operating system 303 runs on processor 301 and provides control and coordinates the functions of the various components of FIG. 3. An application 304 in accordance with the principles of the present disclosure runs in conjunction with operating system 303 and provides calls to operating system 303 where the calls implement the various functions or services to be performed by application 304. Application 304 may include, for example, object importance score generator 201 (FIG. 2) and search relevance score generator 202 (FIG. 2). Furthermore, application 304 may include, for example, a program for discovering objects in a database containing a populated ontology in a manner that efficiently and effectively identifies the relevant data sought by the user as discussed further below in connection with FIGS. 4-5.

Referring again to FIG. 3, read-only memory (“ROM”) 305 is connected to system bus 302 and includes a basic input/output system (“BIOS”) that controls certain basic functions of object discovery system 104. Random access memory (“RAM”) 306 and disk adapter 307 are also connected to system bus 302. It should be noted that software components including operating system 303 and application 304 may be loaded into RAM 306, which may be object discovery system's 104 main memory for execution. Disk adapter 307 may be an integrated drive electronics (“IDE”) adapter that communicates with a disk unit 308, e.g., disk drive. It is noted that the program for discovering objects in a database containing a populated ontology in a manner that efficiently and effectively identifies the relevant data sought by the user, as discussed further below in connection with FIGS. 4-5, may reside in disk unit 308 or in application 304.

Object discovery system 104 may further include a communications adapter 309 connected to bus 302. Communications adapter 309 interconnects bus 302 with an outside network (e.g., network 103 of FIG. 1) thereby allowing object discovery system 104 to communicate with other devices, such as computing device 101.

In one embodiment, application 304 of object discovery system 104 includes the software components of object importance score generator 201 and search relevance score generator 202. In one embodiment, such components may be implemented in hardware, where such hardware components would be connected to bus 302. The functions discussed above performed by such components are not generic computer functions. As a result, object discovery system 104 is a particular machine that is the result of implementing specific, non-generic computer functions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated above, when searching for data in ontologies by the database search system via a search query, the search results may include hundreds or thousands of results. Unfortunately, metadata may not be enough to assist the analyst or data scientist in discovering the relevant data quickly without paging through hundreds or thousands of results. One existing approach to attempt to identify the relevant data sought by the user by the database search system is using text analysis on the search query. Such an approach ranks the similarity of the search query to the ontology concepts. In such an approach though, the results are poor when there is a little amount of text to analyze, such as in a data search. Another approach to attempt to identify the relevant data sought by the user by the database search system is weighting the concepts in an ontology using a probabilistic approach to assess the information content and using those weights to rank the results. However, objects that are associated with many different concepts are penalized. Furthermore, differentiating between objects associated with concept(s) at the same level is difficult. As a result, there is not currently a means for database search systems to efficiently and effectively identify the relevant data sought by the user, such as by effectively ranking the search results. Furthermore, such database search systems expend a tremendous amount of computing resources (e.g., processing resources) in attempting to locate the desired data.

The embodiments of the present disclosure provide a means for efficiently and effectively identifying the relevant data sought by the user as discussed below in connection with FIGS. 4 and 5. FIG. 4 is a flowchart of a method for assessing an object's importance. FIG. 5 is a flowchart of a method for assessing an object's search relevance which is used in combination with the assessed object's importance to discover objects in the ontology database corresponding to the relevant data sought by the user.

As stated above, FIG. 4 is a flowchart of a method 400 for assessing an object's importance in accordance with an embodiment of the present disclosure.

Referring to FIG. 4, in conjunction with FIGS. 1-3, in step 401, object importance score generator 201 of object discovery system 104 queries ontology database 102 for all objects and their associated concepts.

As discussed above, in one embodiment, ontology database 102 contains an ontology which contains a representation, formal naming and definition of the categories, properties and relations between objects and concepts. An “object,” as used herein, refers to a representation of things in the virtual and physical world, such as documents, web pages, description of physical objects within an electronic archive, etc. A “concept,” as used herein, refers to an abstract idea or a general notion, such as a mental representation. For example, the ontology may include the concept of travel associated with the objects of www.travel.state.org; www.cdc.gov; www.dhs.gov; www.ucop.edu; www.fda.gov; “What Documents Do I Need to Travel Overseas?” by Shannon Bradford, etc. In one embodiment, such an ontology may be established an expert.

In step 402, object importance score generator 201 of object discovery system 104 constructs a network with such identified objects as the nodes, where the shared concepts (concepts shared between the objects) are the edges between the objects (the objects with the shared concept). A “shared concept,” as used herein, refers to a concept that is associated with multiple objects in the ontology. For example, the objects of www.travel.state.org and www.cdc.gov are associated with the shared concept of travel. A “node,” as used herein, refers to the vertex of the network. An “edge,” as used herein, refers to a link in the network (or graph) that is one of the connections between the nodes (or vertices) of the network. Edges may be directed, such as pointing from one node to the next. Alternatively, edges may be bidirectional. In one embodiment, the edges are limited to certain types of concept relationships.

In one embodiment, the information used to construct the network discussed in step 402 is obtained from querying ontology database 102 for all objects and their associated concepts in step 401.

In step 403, object importance score generator 201 of object discovery system 104 calculates a score (“object importance score”) for each object in ontology database 102 to determine an object importance based on the number of connections in the network (network constructed in step 402) to other objects as well as based on the number of connections in the network (network constructed in step 402) to those objects (“highly connected objects”) with a number of connections to other objects that exceeds a threshold number. A “connection,” as used herein, refers to the line between the objects in the network. In one embodiment, the higher the number of connections, the higher the score. In one embodiment, each connection corresponds to a point. In one embodiment, based on the highest score calculated for an object in ontology database 102 by object importance score generator 201, the scores are normalized between the values of 0 and 1, with the value of 1 corresponding to the highest score.

In this manner, the potential “usefulness” of an object may be assessed. That is, an importance score is assigned to all objects managed within the ontology based on how these objects connect to each other. As a result, such a score allows for differentiation even when a search is for a single concept with no related concepts. Hence, those objects that are most likely to be “useful” because they contain a large amount of information or act as a connection between other highly useful objects are identified.

In one embodiment, object importance score generator 201 of object discovery system 104 generates such a score via a microservice that is called at the time of a data refresh.

In one embodiment, other object features, such as data quality, may be utilized to calculate the object importance, such as providing a weight to the above-discussed calculations.

In step 404, object importance score generator 201 of object discovery system 104 stores the score calculated in step 403 in ontology database 102 in association with the object whose potential usefulness was evaluated. That is, the object importance score associated with each object is stored within ontology database 102.

While the foregoing discusses calculating a score based on the number of connections in the constructed network of step 402 to other objects and based on the number of connections in the constructed network of step 402 to those objects with a number of connections to other objects that exceeds a threshold number, other network-based measurements directed to assessing the object's potential usefulness may be utilized to make such a calculation. A person of ordinary skill in the art would be capable of applying the principles of the present disclosure to such implementations. Further, embodiments applying the principles of the present disclosure to such implementations would fall within the scope of the present disclosure.

As previously discussed, the embodiments of the present disclosure provide a means for efficiently and effectively identifying the relevant data sought by the user by discovering objects in a database containing a populated ontology (“ontology database”) using a two-stage solution that considers the object relevance to the search terms as well as the object's potential usefulness when ranking the results. In the first stage, the object's potential usefulness is determined as discussed above. In the second stage, the object's search relevance is determined as discussed below in connection with FIG. 5.

FIG. 5 is a flowchart of a method 500 for assessing an object's search relevance which is used in combination with the assessed object's importance to discover objects in the ontology database corresponding to the relevant data sought by the user in accordance with an embodiment of the present disclosure.

Referring to FIG. 5, in conjunction with FIGS. 1-4, in step 501, object discovery system 104 receives a search term from the user of computing device 101 which is used to search ontology database 102.

In step 502, search relevance score generator 202 of object discovery system 104 determines the terms that are synonyms to the received search term. In one embodiment, such synonyms are determined based on a table containing a listing of synonyms for various terms. In one embodiment, search relevance score generator 202 performs a table look-up in such a table using the search term(s) provided by the user of computing device 101 to identify synonyms for such terms. In one embodiment, such a table is stored in a storage device of object discovery system 104 (e.g., memory 305, disk unit 308).

In step 503, search relevance score generator 202 of object discovery system 104 queries ontology database 102 for objects (e.g., documents, web pages, descriptions of physical objects within an electronic archive, etc.) associated with the search term and the search term synonyms. In one embodiment, ontology database 102 contains an ontology which contains a representation, formal naming and definition of the categories, properties and relations between objects. For example, the ontology may include objects associated with various categories. For instance, the objects of www.travel.state.org; www.cdc.gov; www.dhs.gov; www.ucop.edu; www.fda.gov; “What Documents Do I Need to Travel Overseas?” by Shannon Bradford, etc. may be associated with the category of international travel. Hence, if the search term (or search term synonym) included the phrase international travel, then such objects may be identified.

In step 504, search relevance score generator 202 of object discovery system 104 queries ontology database 102 for all terms related to the search term and search term synonyms. In one embodiment, ontology database 102 further contains an ontology which contains a representation. formal naming and definition of the categories, properties and relations between terms. For example, the ontology may include a food ontology class, which includes the category of food, the sub-categories of breads, cereals, rice, pasta and noodles; vegetables and legumes; fruit; milk, yogurt and cheese; meat, fish, poultry, eggs and nuts. Each of these sub-categories may include further sub-categories, such as the sub-category of milk having the further sub-categories of soy milk, almond milk, rice milk, goat milk and cow milk. Hence, if the search term (or search term synonym) included the term “food,” then any of these terms may be identified. In a further example, if the search term (or search term synonym) included the term “milk,” then the terms of soy milk, almond milk, rice milk, goat milk and cow milk may be identified.

In step 505, search relevance score generator 202 of object discovery system 104 constructs a network with the terms and objects discussed above as nodes and the relationships between the terms and objects as edges. A “relationship,” as used herein, refers to the connection in the ontology of ontology database 102 between the terms and objects. In one embodiment, ontology database 102 contains an ontology which contains a representation, formal naming and definition of the categories, properties and relations between the objects and terms. For example, the ontology may include objects associated with various terms, For instance, the term “milk” may be associated with the article of “5 Ways that Drinking Milk can Improve Your Health” by Jillian Kubala and the web page of www.food.com/about/milk-360. Hence, if the term is “milk,” then such objects will be connected to such a term in the constructed network as an edge.

In step 506, search relevance score generator 202 of object discovery system 104 calculates a score (“search relevance score”) for each object in ontology database 102 based on the number of connections in the constructed network of step 505 to the search term and the search term synonyms and based on the number of connections in the constructed network of step 505 to terms related to the search terms (the search term and the search term synonyms). As a result, search relevance scores are assigned to objects based on how closely an object's associated concepts are related to the search concept.

In one embodiment, terms related to the search terms are determined based on querying ontology database 102 for such terms as discussed above. For example, the ontology may include the category for the search term of “milk” with the sub-category of “formula.” Hence, the term “formula” may be identified as being a term related to the search term of “milk.” As a result search relevance score generator 202 generates a score for each object in ontology database 102 based on the number of connections in the constructed network of step 505 to the search term (e.g., “milk”) and the search term synonyms (e.g., “soy milk”) and based on the number of connections in the constructed network of step 505 to terms related to the search terms (e.g., “formula”). In one embodiment, such a score is normalized between the values of 0 and 1, with the value of 1 corresponding to the highest score that was generated by search relevance score generator 202 for an object in ontology database 102.

In one embodiment, search relevance score generator 202 of object discovery system 104 generates such a score via a microservice that is called when the user, such as the user of computing device 101, searches the ontology in ontology database 102.

In step 507, object discovery system 104 combines the object importance score (score generated by object importance score generator 201 in step 403) and the search relevance score (score generated by search relevance score generator 202 in step 506) to obtain a final score for each object in ontology database 102. In one embodiment, such scores are combined by adding the values of the scores together. In one embodiment, such scores are combined by assigning a weight to each of the score values (multiply score value with assigned weight) and then adding the weighted values together. In one embodiment, the amount of the weight assigned to each score value is based on an expert's determination as to which score (e.g., object importance score) is more important in discovering objects in ontology database 102 that most closely corresponds to the desired data sought by the user (i.e., the user of computing device 101 that issued the search term to search ontology database 102). In one embodiment, based on the highest final score for an object in ontology dataset 102, the final scores assigned to the objects in ontology database 102 are normalized between the values of 0 and 1, with the value of 1 corresponding to the highest final score assigned to an object in ontology database 102.

In step 508, object discovery system 104 ranks the objects in ontology database 102 based on their assigned final scores. For instance, objects will be ranked higher than other objects assigned with a lower final score.

In step 509, object discovery system 104 presents the objects from ontology database 102 to a user, such as the user of computing device 101 who submitted the search query, based on their rank. For example, those objects with the highest final scores will be presented to the user of computing device 101 prior to those objects associated with a lower score.

In this manner, the relevance to search terms and the potential usefulness are taken into account when ranking results thereby more efficiently and effectively identifying the relevant data sought by the user. Furthermore, by taking into account the relevance to search terms and the potential usefulness, the objects are identified in the ontology database 102 using fewer computing resource (e.g., fewer processing resources) than prior database search systems.

As a result of the foregoing, embodiments of the present disclosure provide a means for improving the technology or technical field of database search systems by more efficiently and effectively identifying the relevant data sought by the user while at the same time using fewer computing resources (e.g., fewer processing resources) than prior database search systems.

Furthermore, the present disclosure improves the technology or technical field involving database search systems. As discussed above, data is a valuable resource, and reusing such data increases this value. There are many benefits in reusing data, such as eliminating the time in recreating the data as well as increasing innovation. The challenge though with reusing data is the ability to efficiently and effectively locate the desired data, such as in a database, to be reused. A database search system may include a database search engine used to locate such data. Such database search systems may utilize metadata (data about data) to address this challenge by providing additional information about the stored data thereby assisting the user in locating the desired data. Furthermore, ontologies may be utilized to further assist in locating the relevant data. An ontology defines a set of representational primitives with which to model a domain of knowledge or discourse. That is, ontologies are a model of the concepts and objects (e.g., documents, web pages) within a domain and the relationships between those concepts and objects. As a result, ontologies tie metadata together into a cohesive framework thereby making searching for data easier. However, when searching for data in such ontologies by the database search system via a search query, the search results may include hundreds or thousands of results. Unfortunately, metadata may not be enough to assist the analyst or data scientist in discovering the relevant data quickly without paging through hundreds or thousands of results. One existing approach to attempt to identify the relevant data sought by the user by the database search system is using text analysis on the search query. Such an approach ranks the similarity of the search query to the ontology concepts. In such an approach though, the results are poor when there is a little amount of text to analyze, such as in a data search. Another approach to attempt to identify the relevant data sought by the user by the database search system is weighting the concepts in an ontology using a probabilistic approach to assess the information content and using those weights to rank the results. However, objects that are associated with many different concepts are penalized. Furthermore, differentiating between objects associated with concept(s) at the same level is difficult. As a result, there is not currently a means for database search systems to efficiently and effectively identify the relevant data sought by the user, such as by effectively ranking the search results. Furthermore, such database search systems expend a tremendous amount of computing resources (e.g., processing resources) in attempting to locate the desired data.

Embodiments of the present disclosure improve such technology by an object discovery system constructing a first network with objects as the nodes and the shared concepts (concepts shared between the objects) as the edges between the objects (the objects with the shared concept). The object discovery system calculates a score (object importance score) for each object in the ontology database to determine an object importance based on the number of connections in the first network to other objects and based on the number of connections in the first network to the objects with a number of connections to other objects that exceeds a threshold number. After receiving a search term from a user, the object discovery system determines terms that are synonyms to the search term. A second network is then constructed by the object discovery system with nodes corresponding to the terms related to the search term and the search term synonyms and objects associated with the search term and the search term synonyms, where the edges of the second network correspond to the relationships between the terms and the objects. The object discovery system then calculates a score (“search relevance score”) for each object in the ontology database based on the number of connections in the second network to the search term and the search term synonyms and based on the number of connections in the second network to the terms related to the search term and the search term synonyms. These scores (object importance score and the search relevance score) are combined to form a final score for each object. After ranking the objects in the ontology database based on their associated final scores, the object discovery system presents those objects from the ontology database to the user based on their rank, where those objects with the highest final scores will be presented to the user prior to those objects associated with a lower score. In this manner, the relevance to search terms and the potential usefulness are taken into account when ranking results thereby more efficiently and effectively identifying the relevant data sought by the user. Furthermore, by taking into account the relevance to search terms and the potential usefulness, the objects are identified in the ontology database using fewer computing resource (e.g., fewer processing resources) than prior database search systems. Furthermore, in this manner, there is an improvement in the technical field involving database search systems.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for discovering objects in a database containing a populated ontology, the method comprising:
constructing a first network with objects as nodes and shared concepts as edges between said objects;
calculating a first score for each object in said ontology database to determine an object importance based on a number of connections in said first network to other objects and based on a number of connections in said first network to objects with a number of connections to other objects that exceeds a threshold number;
receiving a search term;
determining terms that are synonyms to said search term;
constructing a second network with nodes corresponding to terms related to said search term and said search term synonyms and objects associated with said search term and said search term synonyms, wherein edges of said second network correspond to relationships between said terms related to said search term and said search term synonyms and said objects associated with said search term and said search term synonyms;
calculating a second score for each object in said ontology database based on a number of connections in said second network to said search term and said search term synonyms and based on a number of connections in said second network to said terms related to said search term and said search term synonyms;
combining said first and second scores to obtain a final score for each object in said ontology database;
ranking objects in said ontology database based on associated final scores; and
presenting objects from said ontology database to a user based on their associated rank.

2. The method as recited in claim 1 further comprising:
querying said ontology database for all objects and their associated concepts.

3. The method as recited in claim 1 further comprising:
storing said first score associated with each object within said ontology database.

4. The method as recited in claim 1 further comprising:
querying said ontology database for said objects associated with said search term and said search term synonyms.

5. The method as recited in claim 1 further comprising:
querying said ontology database for said terms related to said search term and said search term synonyms.

6. The method as recited in claim 1, wherein data quality is used as a weight in said calculated first score.

7. The method as recited in claim 1, wherein said presented objects from said ontology database comprise one or more of the following: documents, web pages and descriptions of physical objects within an electronic archive.

8. A computer program product for discovering objects in a database containing a populated ontology, the computer program product comprising one or more computer readable storage mediums having program code embodied therewith, the program code comprising programming instructions for:
constructing a first network with objects as nodes and shared concepts as edges between said objects;
calculating a first score for each object in said ontology database to determine an object importance based on a number of connections in said first network to other objects and based on a number of connections in said first network to objects with a number of connections to other objects that exceeds a threshold number;
receiving a search term;
determining terms that are synonyms to said search term;
constructing a second network with nodes corresponding to terms related to said search term and said search term synonyms and objects associated with said search term and said search term synonyms, wherein edges of said second network correspond to relationships between said terms related to said search term and said search term synonyms and said objects associated with said search term and said search term synonyms;
calculating a second score for each object in said ontology database based on a number of connections in said second network to said search term and said search term synonyms and based on a number of connections in said second network to said terms related to said search term and said search term synonyms;
combining said first and second scores to obtain a final score for each object in said ontology database;
ranking objects in said ontology database based on associated final scores; and
presenting objects from said ontology database to a user based on their associated rank.

9. The computer program product as recited in claim 8, wherein the program code further comprises the programming instructions for:
querying said ontology database for all objects and their associated concepts.

10. The computer program product as recited in claim 8, wherein the program code further comprises the programming instructions for:
storing said first score associated with each object within said ontology database.

11. The computer program product as recited in claim 8, wherein the program code further comprises the programming instructions for:
querying said ontology database for said objects associated with said search term and said search term synonyms.

12. The computer program product as recited in claim 8, wherein the program code further comprises the programming instructions for:
querying said ontology database for said terms related to said search term and said search term synonyms.

13. The computer program product as recited in claim 8, wherein data quality is used as a weight in said calculated first score.

14. The computer program product as recited in claim 8, wherein said presented objects from said ontology database comprise one or more of the following: documents, web pages and descriptions of physical objects within an electronic archive.

15. A strategic planning system, comprising:
a memory for storing a computer program for discovering objects in a database containing a populated ontology; and
a processor connected to said memory, wherein said processor is configured to execute program instructions of the computer program comprising:
constructing a first network with objects as nodes and shared concepts as edges between said objects;
calculating a first score for each object in said ontology database to determine an object importance based on a number of connections in said first network to other objects and based on a number of connections in said first network to objects with a number of connections to other objects that exceeds a threshold number;
receiving a search term;
determining terms that are synonyms to said search term;
constructing a second network with nodes corresponding to terms related to said search term and said search term synonyms and objects associated with said search term and said search term synonyms, wherein edges of said second network correspond to relationships between said terms related to said search term and said search term synonyms and said objects associated with said search term and said search term synonyms;
calculating a second score for each object in said ontology database based on a number of connections in said second network to said search term and said search term synonyms and based on a number of connections in said second network to said terms related to said search term and said search term synonyms;
combining said first and second scores to obtain a final score for each object in said ontology database;
ranking objects in said ontology database based on associated final scores; and
presenting objects from said ontology database to a user based on their associated rank.

16. The system as recited in claim 15, wherein the program instructions of the computer program further comprise:
querying said ontology database for all objects and their associated concepts.

17. The system as recited in claim 15, wherein the program instructions of the computer program further comprise:
storing said first score associated with each object within said ontology database.

18. The system as recited in claim 15, wherein the program instructions of the computer program further comprise:
querying said ontology database for said objects associated with said search term and said search term synonyms.

19. The system as recited in claim 15, wherein the program instructions of the computer program further comprise:
querying said ontology database for said terms related to said search term and said search term synonyms.

20. The system as recited in claim 15, wherein data quality is used as a weight in said calculated first score.
